(19) United States
(12) Patent Application Publication
(10) Pub. No.: US 2003/0155764 A1
(43) Pub. Date: Aug. 21, 2003

(54) Air plug and pneumatically operated tool provided with the air plug

(75) Inventors: Yoshinori Ishizawa, Hitachinaka-shi (JP); Masanori Aoki, Hitachinaka-shi (JP); Yoshihiro Nakano, Hitachinaka-shi (JP)

Correspondence Address: SUGHRUE MION, PLLC, 2100 PENNSYLVANIA AVENUE, N.W., WASHINGTON, DC, 20037, US

(73) Assignee: HITACHI KOKI CO., LTD.

(21) Appl. No.: 10/360,813

(22) Filed: Feb. 10, 2003

(30) Foreign Application Priority Data
Feb. 15, 2002 (JP) P2002-37785

(51) Int. Cl. F16L 25/00

(52) U.S. Cl. 285/94; 285/332.2

(57) ABSTRACT

An air plug assembled into a pneumatically operated tool. The air plug is detachably connected to an air coupler which is connected to a compressed air source through a hose. When the air plug is disconnected from the air coupler, one end of the air plug is utilized as an oil supply portion. The air plug is formed with an air passage extending throughout a length of the air plug. The one end of the air plug is formed with an air inlet hole also serving as an oil supply hole for maintenance to the pneumatically operated tool. The oil supply hole has a conical shape increasing its inner diameter toward the one distal end. The conical configuration of the oil supply hole provides a maximum inner diameter at the open end which is not more than twice as large as a diameter of a tip end of a nozzle of a lubricator.

### BACKGROUND OF THE INVENTION

The present invention relates to an air plug in a pneumatically operated tool, the air plug being detachably connected to a compressed air source. The present invention also relates to a pneumatically operated power tool provided with such air plug.

Generally, an air plug is provided for pneumatically connecting a compressed air source through an air hose and an air coupler to a pneumatically operated tool such as a nail gun and a screw driver for applying compressed air to the pneumatically operated tool. The air plug is detachably connected to the air coupler. Normally, the air plug is connected to the tool side so that the air accumulated in the tool can be discharged to atmosphere when the air plug is detached from the air coupler.

U.S. Pat. No. 5,582,204 discloses a combination of an air plug and an air coupler. As shown in FIG. 5, an air plug 101 connected to pneumatically operated tool (not shown) detachably connected to an air coupler 120 connected to a compressed air source (not shown) through an air hose (not shown). The air plug 101 is formed with an air passage 102 along its length, and has one end portion serving as an attachment portion 103 attached to a main body of the pneumatically operated tool, and has another end wall 104 formed with an air inlet hole 105. A plurality of radial holes 106 are formed near the end wall 104 at an equal interval in a circumferential direction of the plug 101 for permitting the air to discharge therethrough when the air plug 101 is disconnected from the air coupler 120. These radial holes 106 can prevent the body of the pneumatically operated tool from being jumped or moved at random upon immediate ejection of the compressed air remaining in the pneumatically operated tool through the inlet hole 105 after the detachment of the plug 101 from the coupler 120. An annular groove 107 is formed at an outer peripheral surface of the air plug body.

The coupler 120 includes an air hose connecting portion 121 and a coupling portion 122. The coupling portion 122 includes a sleeve 123 with which the air plug 101 is fitted. The sleeve 123 has an inner peripheral portion provided with a valve seat 124, and has an outer peripheral portion provided with a locking sleeve 125. The locking sleeve 125 has a ball seat portion positioned in confrontation with the annular groove 107 by a biasing force of a spring 126 interposed between the sleeve 123 and the locking sleeve 125. Balls 127 is positioned engageable with the annular groove 107, so that the plug 101 can be engaged with the coupler 120. These balls 127 can be disengaged from the annular groove 107 upon sliding the locking sleeve 125 toward the hose connecting portion 121 against the biasing force of the spring 126, so that the ball seat portion can be displaced from the balls 127.

In the sleeve 123, a self-seal valve 128 is disposed, and a spring 129 is interposed between the self-seal valve 128 and the hose connecting portion 121 for biasing the self-seal valve 128 toward the valve seat 124. The self-seal valve 128 has an abutment portion 128A in abutment with the end wall 104 of the air plug 101. The abutment portion 128A does not completely close the air inlet hole 105 when the end wall 104 is brought into abutment with the abutment portion 128A.

When the air plug 101 is inserted into the coupler 120, the end wall 104 pushes the self-seal valve 128 against the biasing force of the spring 129. Therefore, compressed air can be introduced into the pneumatically operated tool through the inlet hole 105, the plurality of radial holes 106 and the air passage 102. If the air plug 101 is disconnected from the coupler 120, the self-seal valve 128 is seated onto the valve seat 124 to shut off the compressed air source from the atmosphere. In this case, compressed air remaining in the pneumatically operated tool is discharged outside through not only the inlet hole 105 but also the plurality of radial hole 106, thereby decreasing amount of air to be released through the air inlet hole 105 to avoid random movement of the tool body.

In case of a pneumatically operated tool operated at relatively high pneumatic pressure such as from 10 to 30 kgf/cm², the portion of the air plug engaging the coupler 120 has an outer diameter D1 of 7.1 mm so as to reduce pressure receiving area of the air plug 101 in order to reduce a load imparting in the axial direction of the plug 101. Incidentally, a pneumatically operated tool operated at ordinary pressure level of from 7 to 10 kgf/cm², the outer diameter D1 is about 13.2 mm.

Further, periodical oil supply is required in the pneumatically operated tool. The compressed air supplied from the compressor contains moisture, dust and drain which is a mixture of the moisture and oil released from the compressor. Therefore, oil supply is required in the tool for the purpose of lubrication, cleaning and prevention of rust, otherwise operation of the tool may be degraded and durability of the tool may be lowered.

Oil supply to the pneumatically operated tool is performed through the air inlet 105 and the air passage 102 employing a lubricator having a nozzle. That is, the air inlet 105 serves as an oil supply hole. However, in case of the pneumatically operated tool operated at high pneumatic pressure, the diameter D1 must be decreased as described above. Decrease in diameter D1 implies a decrease in a diameter of the air inlet hole 105. In order to avoid random movement of the tool body upon detachment of the air plug 101 from the coupler 120, the plurality of radial holes 106 must be formed, otherwise movement of the tool body is accelerated due to the air ejection through the narrow air inlet hole 105.

To this effect, the nozzle of the lubricator should provide a small outer diameter so that the nozzle can be inserted into the air plug 101 having the small diameter. Further, tip end of the nozzle must exceed the plurality of radial holes 106 after complete insertion of the nozzle into the air inlet hole 105 maintaining an axial alignment of the nozzle with the air passage. Incidentally, a diameter of a tip end of the nozzle is 1.8 mm.

Still however, an aged user cannot clearly observe such a fine area due to his hypermetropia, or the user cannot align the tip end of the nozzle of the lubricator with the oil supply hole 105 due to shaking of his hand. Thus, it would be difficult to perform oil supply.

In order to avoid shaking of the hand, a body of the lubricator is held by the forefinger and the thumb while the pneumatically operated tool is held by the middle finger, the third finger and the little finger. In this case, an axis of the nozzle is inclined at about 60 degrees with respect to an axis of the air passage 102, and therefore, the tip end of the nozzle cannot be correctly inserted through the oil supply hole 105.

### SUMMARY OF THE INVENTION

It is therefore an object of the present invention to overcome the above-described drawbacks, and to provide an improved air plug and a pneumatically operated tool having such air plug which facilitates insertion of a nozzle tip into an oil supply hole, even if the oil supply hole has a small diameter.

This and other object of the present invention will be attained by an air plug for pneumatically connecting a compressed air source to a body of a pneumatically operated tool, the air plug is in a form of a tubular body formed with an air passage extending throughout a length of the tubular body. The tubular body has one end provided with an end wall to be connected to the compressed air source and has another end portion in communication with the body of the pneumatically operated tool. The one end wall is formed with an air inlet hole in communication with the air passage for introducing a compressed air into the air passage therethrough. The air inlet hole serves as an oil supply hole to allow a nozzle of a lubricator to be inserted therethrough, and the oil supply hole provides a cross-sectional area gradually increased toward the one end.

In another aspect of the invention, there is provided a pneumatically operated tool including a main body having a connecting portion, and the air plug assembled to the connecting portion. The air plug is detachably connected to an air coupler which is connected to a compressed air source by an air hose for pneumatically connecting the compressed air source to the main body. The air plug includes the above described tubular body.

### BRIEF DESCRIPTION OF THE DRAWINGS

In the drawings:

FIG. 1 is a cross-sectional view showing a pneumatically operated tool having an air plug according to a first embodiment of the present invention;

FIG. 2 is a cross-sectional view showing a pneumatically operated tool having an air plug and showing a state where a nozzle of a lubricator extends in parallel to the air plug according to a second embodiment of the present invention;

FIG. 3 is a cross-sectional view showing the pneumatically operated tool having the air plug and showing a state where a nozzle of a lubricator is tilted for oil supply according to the second embodiment;

FIG. 4 is an enlarged cross-sectional view showing an end portion of the air plug and the nozzle according to the second embodiment; and

FIG. 5 is a cross-sectional view showing a coupling state of a conventional air plug to an air coupler.

### DETAILED DESCRIPTION OF THE PREFERRED EMBODIMENTS

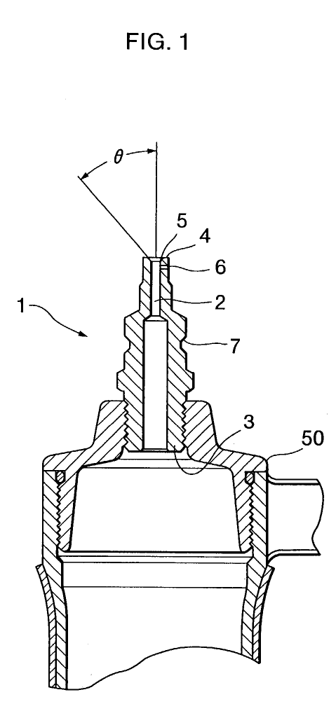

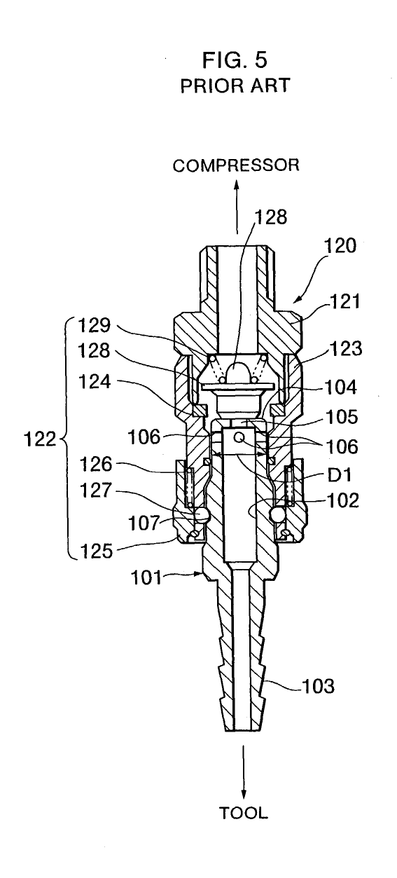

A pneumatically operated tool having an air plug according to a first embodiment of the present invention will be described with reference to FIG. 1. An air plug 1 is connected to a main body 50 of a nail gun as a pneumatically operated tool. The air plug 1 is formed with an air passage 2 extending throughout a length thereof. The air plug 1 has one end portion 3 formed with a male thread threadingly engaged with a female thread of the main body 50. The air plug 1 has an intermediate portion formed with an annular groove 7 with which engaging balls (corresponding to ball 127 of FIG. 5) is engageable. The air plug 1 has another end wall 4 at which an air inlet hole 5 is formed. Further, a plurality of radial holes (three holes) 6 are formed near the end wall 4 for allowing compressed air remaining in the main body 50 to discharge toward outside when the air plug 1 is disengaged from an air coupler (corresponding to the coupler 120 of FIG. 5).

The air inlet hole 5 also serves as an oil inlet hole. The air inlet hole 5 has a conical shape in which an inner diameter is gradually reduced toward the one end portion 3. More specifically, an inner diameter of the air passage 2 at the other end portion of the air plug 1 is 3.6 mm, an inner diameter of the radial holes 6 is 2 mm, and the oil inlet hole 5 is slanted at an angle θ of 45 degrees with respect to an axis of the air passage 2, so that a maximum inner diameter of the oil inlet hole 5, i.e., an open end diameter of the oil inlet hole 5 is 4 mm and a minimum diameter of the oil inlet hole 5 is equal to the inner diameter of the air passage 2.

On the other hand, a lubricator (not shown) has a nozzle to be inserted through the oil inlet hole 5. A tip end of the nozzle has an outer diameter of 1.8 mm. Therefore, the open end diameter of the oil inlet hole 5 is about 2.2 times as large as the outer diameter at the tip end of the nozzle. Consequently, the tip end of the nozzle can be easily guided into the air passage 2 along the guidance of the slanted oil inlet hole 5. Further, because the complete insertion of the nozzle tip into the air passage 2 can be provided, the nozzle tip can exceed the radial holes 6. Therefore, unwanted oil leakage through the radial holes 6 during oil supply can be avoided.

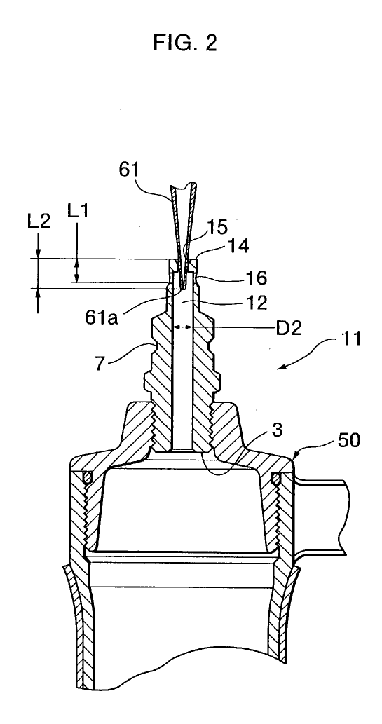

A pneumatically operated tool having an air plug according to a second embodiment of the present invention will be described with reference to FIGS. 2 through 4 wherein like parts and components are designated by the same reference numerals as those shown in FIG. 1. In an air plug 11 of the second embodiment, similar to the first embodiment, an oil supply hole 15 has a conical portion 15a in which an inner diameter is gradually reduced toward the one end portion 3. However, a minimum diameter of the oil inlet hole 15 is not equal to the inner diameter of an air passage 12, but is smaller than that of the air passage 12.

In the second embodiment, an inner diameter D2 of the air passage 12 is 3.6 mm, an inner diameter of the radial holes 16 is 2 mm, and the oil inlet hole 15 is slanted at an angle θ ranging from 1 to 30 degrees with respect to an axis of the air passage 12, so that a maximum inner diameter D3 of the oil inlet hole 15, i.e., an open end diameter of the oil inlet hole 15 is 4 mm and a minimum diameter of the oil inlet hole 15 is 2 mm which is smaller than the diameter D2 of the air passage 12.

A lubricator (not shown) has a nozzle 61 to be inserted through the oil inlet hole 15. A tip end 61a of the nozzle 61 has an outer diameter D4 of 1.8 mm. Therefore, the open end diameter D3 of the oil inlet hole 15 is about 2.2 times as large as the outer diameter D4 at the tip end 61a of the nozzle. Consequently, the tip end of the nozzle can be easily guided into the air passage 12 along the guidance of the slanted oil inlet hole 15. Further, because the complete insertion of the nozzle 61 into the air passage 12 can be provided, the nozzle tip can exceed the radial holes 16. That is, in FIG. 2, a distance L1 between the end wall 14 and the radial hole 16 is smaller than a distance L2 between the end wall 14 and the tip end 61a of the nozzle 61. Therefore, unwanted oil leakage through the radial holes 6 during oil supply can be avoided.

Further in case of the oil supply into the main body 50, air is leaked through the oil supply hole 15 by an amount equal to an amount of the supplied oil. In case of the first embodiment, since the inner diameter of the air passage 2 is equal to the minimum diameter of the oil supply hole 5, air as well as oil may be leaked through a minute space between the inserted nozzle and the oil supply hole 5. In contrast, according to the second embodiment, since the inner diameter of the air passage 12 is greater than the minimum diameter of the oil supply hole 15, the above-described oil leakage can be prevented.

Even if the nozzle 61 is maintained in parallel with the air passage 12 for its insertion into the oil supply hole 15, the tip end of the nozzle can be easily guided into the oil supply hole 15, because the maximum diameter D3 of the oil supply hole 15 is more than-twice as large as the tip end diameter D4 of the nozzle.

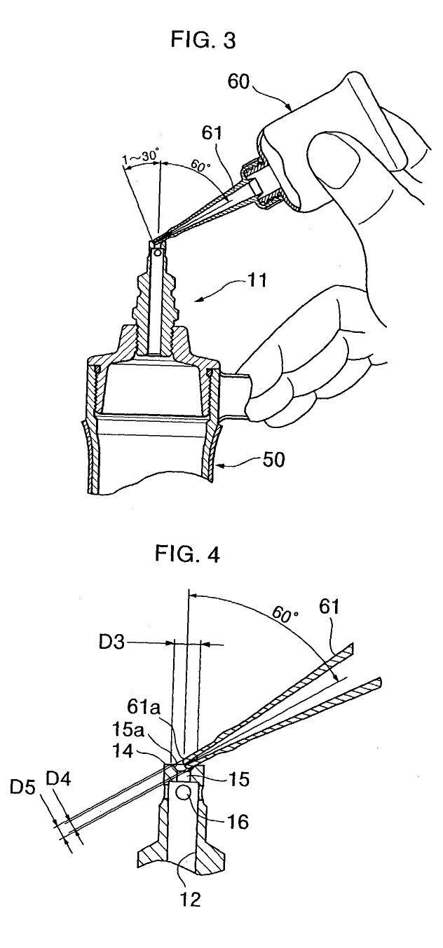

Further, as shown in FIGS. 3 and 4, a posture of a lubricator body 60 is held so that its nozzle 61 is inclined at an angle of 60 degrees with respect to the axis of the air passage 12 for supplying oil into the tool 50. This angle of 60 degrees is the typical inclination angle when the lubricator body 60 is held by the forefinger and the thumb while the main body 50 of the tool is held by the middle finger, the third finger and the little finger. The diameter D3 corresponds to a diameter D5 (D3×cos 60=2 mm) if the nozzle is slanted at the angle of 60 degrees. Because D5 is greater than D4, the nozzle tip 61a can still be guided by the slant wall 15a of the oil supply hole 15, so that the nozzle 61 can be sufficiently inserted into the air passage 12.

Furthermore, because the slant wall 15a is inclined at an angle ranging from 1 to 30 degrees, an angle defined between the axis of the nozzle 61 and the slant wall 15a is less than 90 degrees when the nozzle is slantingly held at the angle of 60 degrees with respect to the axis of the air passage. This angle of less than 90 degrees can promote smooth sliding movement of the nozzle tip 61a with respect to the slant wall 15a, which facilitates smooth insertion of the nozzle tip into the air passage 12.

While the invention has been described in detail and with reference to specific embodiments thereof, it would be apparent to those skilled in the art that various changes and modifications may be made therein. For example, instead of the linear cross-sectional shape of the slanted wall of the oil supply hole 5, the oil supply hole can be formed by an arcuate wall or a combination of an arcuate wall and a linear wall.

What is claimed is:

1. An air plug for pneumatically connecting a compressed air source to a body of a pneumatically operated tool, comprising a tubular body formed with an air passage extending throughout a length of the tubular body, the tubular body having one end provided with an end wall to be connected to the compressed air source and having another end portion in communication with the body of the pneumatically operated tool, the end wall being formed with an air inlet hole in communication with the air passage for introducing a compressed air into the air passage therethrough, the air inlet hole serving as an oil supply hole to allow a nozzle of a lubricator to be inserted therethrough, and the oil supply hole providing a cross-sectional area gradually increased toward the one end.

2. The air plug as claimed in claim 1, wherein the air inlet hole has a conical shape.

3. The air plug as claimed in claim 1, wherein the oil supply hole has an open end diameter at the one end not more than twice as large as a diameter of a tip end of the nozzle.

4. The air plug as claimed in claim 1, wherein the air passage has an inner diameter and the oil supply hole has an inner open end connecting to the air passage, the inner open end having a diameter smaller than the inner diameter of the air passage.

5. The air plug as claimed in claim 4, wherein the tubular body is formed with a plurality of radial holes at a position close to the one end, the plurality of radial holes penetrating through a radial thickness of the tubular body for fluid communication with the air passage.

6. The air plug as claimed in claim 1, wherein the tubular body is formed with a plurality of radial holes at a position close to the one end, the plurality of radial holes penetrating through a radial thickness of the tubular body for fluid communication with the air passage.

7. A pneumatically operated tool comprising:
a main body having a connecting portion; and
an air plug assembled to the connecting portion, the air plug being detachably connected to an air coupler which is connected to a compressed air source by an air hose for pneumatically connecting the compressed air source to the main body, the air plug comprising a tubular body formed with an air passage extending throughout a length of the tubular body, the tubular body having one end provided with an end wall to be connected to the air coupler and having another end portion in communication with the main body, the end wall being formed with an air inlet hole in communication with the air passage for introducing a compressed air into the air passage therethrough, the air inlet hole serving as an oil supply hole to allow a nozzle of a lubricator to be inserted therethrough, and the oil supply hole providing a cross-sectional area gradually increased toward the one end.

8. The pneumatically operated tool as claimed in claim 7, wherein the air inlet hole has a conical shape.

9. The pneumatically operated tool as claimed in claim 7, wherein the oil supply hole has an open end diameter at the one end not more than twice as large as a diameter of a tip end of the nozzle.

10. The pneumatically operated tool as claimed in claim 7, wherein the air passage has an inner diameter and the oil supply hole has an inner open end connecting to the air passage, the inner open end having a diameter smaller than the inner diameter of the air passage.

11. The pneumatically operated tool as claimed in claim 10, wherein the tubular body is formed with a plurality of radial holes at a position close to the one end, the plurality of radial holes penetrating through a radial thickness of the tubular body for fluid communication with the air passage.

12. The pneumatically operated tool as claimed in claim 7, wherein the tubular body is formed with a plurality of radial holes at a position close to the one end, the plurality of radial holes penetrating through a radial thickness of the tubular body for fluid communication with the air passage.
